(19) United States
(12) Patent Application Publication
(10) Pub. No.: US 2008/0046832 A1
(43) Pub. Date: Feb. 21, 2008

(54) Notification of state transition of an out-of-focus application

(75) Inventor: Swaminathan Balasubramanian, Ypsilanti, MI (US)

Correspondence Address: SCHMEISER, OLSEN & WATTS, 22 CENTURY HILL DRIVE, SUITE 302, LATHAM, NY, 12110, US

(73) Assignee: International Business Machines Corporation, Armonk, NY (US)

(21) Appl. No.: 11/505,131

(22) Filed: Aug. 15, 2006

(51) Int. Cl. G06F 9/00

(52) U.S. Cl. 715/767; 715/802; 715/835; 715/837

(57) ABSTRACT

A method, a computer program product, a computer system and a method for supporting an application. The method includes: monitoring the state of a software application, the application having multiple possible states, the application running in out-of-focus mode; displaying a displayed icon on a computer screen indicating a current state of the application; and in response to a change of state of the application from the current state to a new state, changing the displayed icon representing the current state to a different displayed icon representing the new state, the application continuing to run in out-of-focus mode.

### FIELD OF THE INVENTION

The present invention relates to the field of computer software; more specifically, it relates to method for notification of a user of a state transition of an out-of-focus software application.

### BACKGROUND OF THE INVENTION

The widespread availability of high performance computers has enabled users to run multiple applications simultaneously on their workstations. This has resulted in applications competing for user attention and interruptions of applications the user is currently interfacing with. Furthermore, there is no uniform methodology for applications to obtain the users attention. Users are thus subject to interruptions and productivity is adversely affected when an application is idle and waiting for user attention or the user is forced to transfer their attention to another application.

Therefore, there is a need for a method for applications to notify the user of an applications status and need for attention without interrupting the user and the application the user is currently working with.

### SUMMARY OF THE INVENTION

A first aspect of the present invention is a method, comprising: monitoring the state of a software application, the application having multiple possible states, the application running in out-of-focus mode; displaying a displayed icon on a computer screen indicating a current state of the application; and in response to a change of state of the application from the current state to a new state, changing the displayed icon representing the current state to a different displayed icon representing the new state, the application continuing to run in out-of-focus mode.

A second aspect of the present invention is a computer program product, comprising a computer useable medium having; a computer readable program, wherein the computer readable program when executed on a computer causes the computer to: execute an application coded in the computer readable program; monitor the state of the application, the application having multiple possible states, the application running in out-of-focus mode; display a displayed icon on a computer screen indicating a current state of the application; and in response to a change of state of the application from the current state to a new state, change the displayed icon representing the current state to a different displayed icon representing the new state, the application continuing to run in out-of-focus mode.

A third aspect of the present invention is a computer system comprising a processor, an address/data bus coupled to the processor, and a computer-readable memory unit coupled to communicate with the processor, the memory unit containing instructions that when executed implement a method for dynamically notifying a user of a change in state of an application running on the computer system, the method comprising the computer implemented steps of: monitoring the state of the application, the application having multiple possible states, the application running in out-of-focus mode; displaying a displayed icon on a computer screen indicating a current state; of the application; and in response to a change of state of the application from the current state to a new state, changing the displayed icon representing the current state to a different displayed icon representing the new state, the application continuing to run in out-of-focus mode.

A fourth aspect of the present invention is a method for supporting an application, comprising: supporting the application, wherein the application is operable to perform the following functions: monitoring the state of the application, the application having multiple possible states, the application running in out-of-focus mode; displaying a displayed icon on a computer screen indicating a current state of the application; and in response to a change of state of the application from the current state to a new state, changing the displayed icon representing the current state to a different displayed icon representing the new state, the application continuing to run in out-of-focus mode.

### BRIEF DESCRIPTION OF DRAWINGS

The features of the invention are set forth in the appended claims. The invention itself, however, will be best understood by reference to the following detailed description of an illustrative embodiment when read in conjunction with the accompanying drawings, wherein:

FIG. 1 is a schematic drawing of a user desktop illustrating an in-focus application and an out-of-focus application running simultaneously according to embodiments of the present invention;

FIG. 2 is a schematic drawing of a user desktop illustrating the out-of-focus application indicating normal activity according to embodiments of the present invention;

FIG. 3 is a schematic drawing of a user desktop illustrating the out-of-focus application indicating user response required according to embodiments of the present invention;

FIG. 4 is a schematic drawing of a user desktop illustrating the out-of-focus application indicating an error has occurred according to embodiments of the present invention;

FIG. 5 is a schematic drawing of a user desktop after a user response to an error message of the out-of-focus application according to embodiments of the present invention;

FIG. 6 is a schematic drawing of an alternative user desktop after a user response to an error message of the out-of-focus application according to embodiments of the present invention;

FIGS. 7A and 7B are flowcharts illustrating the method of user notification of a state transition of an out-of-focus application according to embodiments of the present invention;

FIG. 8 is a system diagram for implementing the method of user notification of a state transition of an out-of-focus application according to embodiments of the present invention; and

FIG. 9 is a schematic block diagram of a general-purpose computer for practicing the embodiments of the present invention.

### DETAILED DESCRIPTION OF THE INVENTION

A window is defined as a visual area containing a user interface displaying the output of and allowing input to a number of simultaneously running computer processes. A control widget is defined as means that a computer user interacts with in order to control and interface component such as a window or a text box. Control widgets come in two forms, virtual and physical. A button is an example of a control widget. A virtual button can be clicked with a mouse cursor while a physical button can be pressed with a finger.

In computing, the focus is the component of the graphical user interface, which is currently selected. Text entered at a keyboard or pasted from a clipboard is sent to the application, which currently has the focus. Graphical user interfaces also use a mouse cursor. Moving the mouse will typically move the mouse cursor over the screen and windows displayed on the screen without changing the focus. In a Microsoft™ windows system or an Apple™ computer, the focus can be changed by clicking on a component that can receive focus with the mouse. Clicking a mouse button when the mouse cursor is over a window selects the window to be in-focus. This is called a “focus follows click” policy or “click to focus”. Focus may also be changed using the keyboard. In a UNIX computer system the “focus follows the mouse cursor” policy is used.

An in-focus application is defined as an running application that has been selected by a control widget and to which any user input will be directed. For example, placing a cursor over a window and clicking a mouse button will put the application running in the window in focus and keyboard strokes will be inputted into the in-focus application. A out-of-focus application is a running application to which user input is not directed. For example, any keyboard strokes will be not be inputted into the out-of-focus application. Alternatively, an out-of-focus application can be defined as an application that is not in focus.

When multiple applications are running (running includes time when the application is idle, i.e., the application is loaded into memory but not processing), one application is considered “in-focus” and the others are considered “out-of-focus”. Idle applications can receive input, but only when they are in-focus. Control widgets within windows may require a further click to focus them, to differentiate the different places input may go.

Examples of applications include, but are not limited to, word processors, spread sheets, computer aided design (CAD) programs, audio, picture and video editing programs, communication programs, email programs web browsers and various utility programs.

In certain operating systems, such as Microsoft™ Windows, the computer screen displays a desktop, which may include application desktop icons (control widgets) and a task bar (control widget). In the task bar a task button (control widget) is displayed for each running application. The task button includes a task button icon and a title. In-focus and out-of-focus applications may also appear in windows displayed on the desktop. The in-focus application is indicated by a highlighted task button and/or highlighted window associated with the in-focus application. A title-bar appears at the top of the window. The exit, minimize and restore/maximize buttons found in the upper right hand corner of the title bar are control widgets.

There are several types of special windows in a graphical user interface in addition to the application/document window displaying the application. One type of special window is a dialog box. In a dialog box appears when communication is requested or required outside the applications normal workflow between the application or operating system and the user. A dialog box is another type of widget. In non-model or modeless dialog box focus is not changed when it appears. In a modal dialog box, focus is changed to the dialog box.

The embodiments of the present invention will be described in the context of a windows-like operating system that utilizes a task bar, but is applicable to other types of operating systems such as UNIX, which do not use a task bar, but do display icons on the desktop. In the case of such operating systems, the features of the present invention are applied to the desktop icon instead of the task button icon. Alternatively, for applications that do use a desktop icons and task bar task button icons, icon overlays may be applied to both the desktop icons and the task button icons.

In one example, the present invention modifies the task button icons by adding an icon overlay to the task button icon. The icon overlay indicates the state of the application and changes when the application changes state (transitions between states) in order to dynamically notify the user of a change in state of the applications without forcing itself on the user. Icon overlays may be applied to only out-of-focus applications or both in-focus and out-of-focus applications.

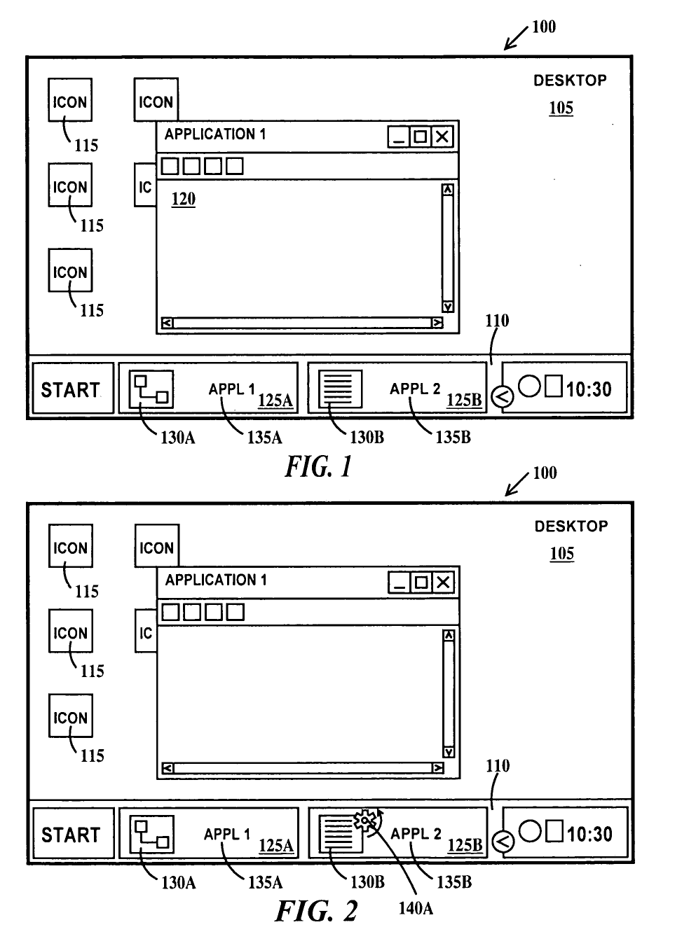

FIG. 1 is a schematic drawing of a user desktop illustrating an in-focus application and an out-of-focus application running simultaneously according to embodiments of the present invention. In FIG. 1, a desktop 100 (displayed on a computer screen) includes a workspace region 105 and a task bar region 110. Displayed in workspace region are icons 115 for various applications and a window 120 displaying an in-focus application. Task bar region 110 includes a first task button 125A and a second task button 125B. First task button 125A includes a task button icon 130A and a title 135A (APPL 1). Second task button 125B includes a task button icon 130B and a title 135B (APPL 2). First task button 125A is associated with a first application running in window 120. Second task button 125B is associated with a second out-of-focus application. Task button icon 130B is the standard task button icon for the second application. The absence of an overlay icon indicates the second application is loaded but is in a state that does not require user notification (for example, idle).

FIG. 2 is a schematic drawing of a user desktop illustrating the out-of-focus application indicating normal activity according to embodiments of the present invention. In FIG. 2, the second application has changed state and is now running. To inform the user of the new status of the second application an overlay icon 140A is imposed over standard icon 130B. Overlay icon 140A may be animated. In the example of FIG. 2, overlay icon 140A is a spinning gear. Alternatively, standard icon 130B is replaced with a whole new icon that includes the overlay icon 140A graphics.

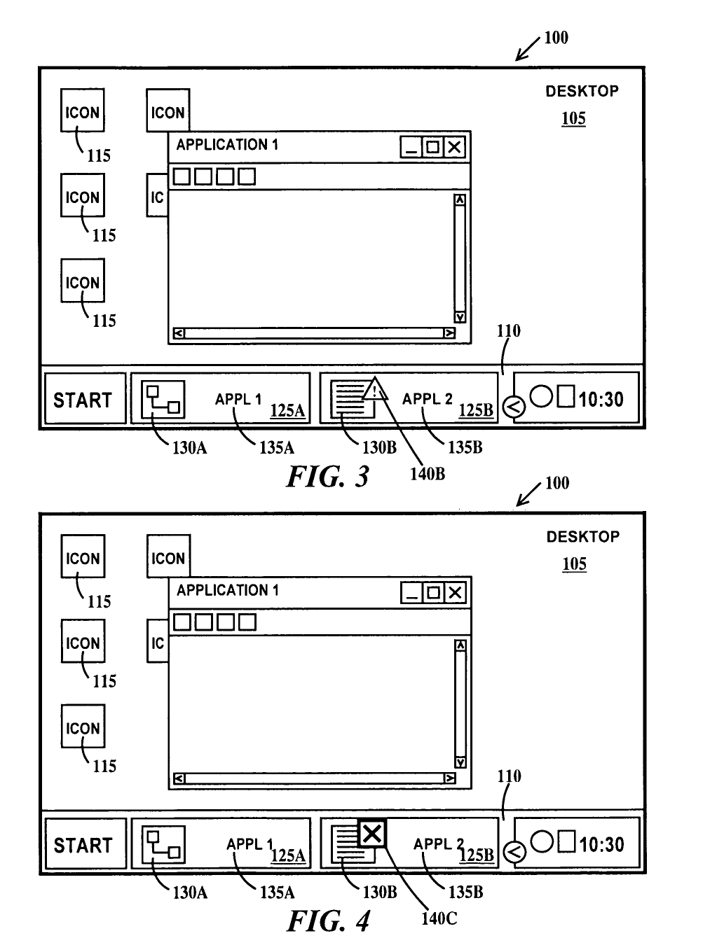

FIG. 3 is a schematic drawing of a user desktop illustrating the out-of-focus application indicating user response required according to embodiments of the present invention. In FIG. 3, the second application has again changed to a new state where processing has been stopped because user input is required. To inform the user of the new status of the second application (i.e., processing stopped because input is required) an overlay icon 140B is imposed over standard icon 130B. In the example of FIG. 3, overlay icon 140B is triangle with an exclamation point. In one example, the color of overlay icon may be selected to enhance the visual clue given by the presence of the overlay icon graphics. For example, overlay icon 140B may have a yellow background. In one example, an audio clue may be associated with overlay icon 140B. Combinations of animation, audio and color clues may be used together. Alternatively, standard icon 130B (see FIG. 1) is replaced with a whole new icon that includes the overlay icon 140B graphics. The out-of-focus application remains out-of-focus until the user presses second task button 125B, which will bring the second application up in a window so the user may supply the required input.

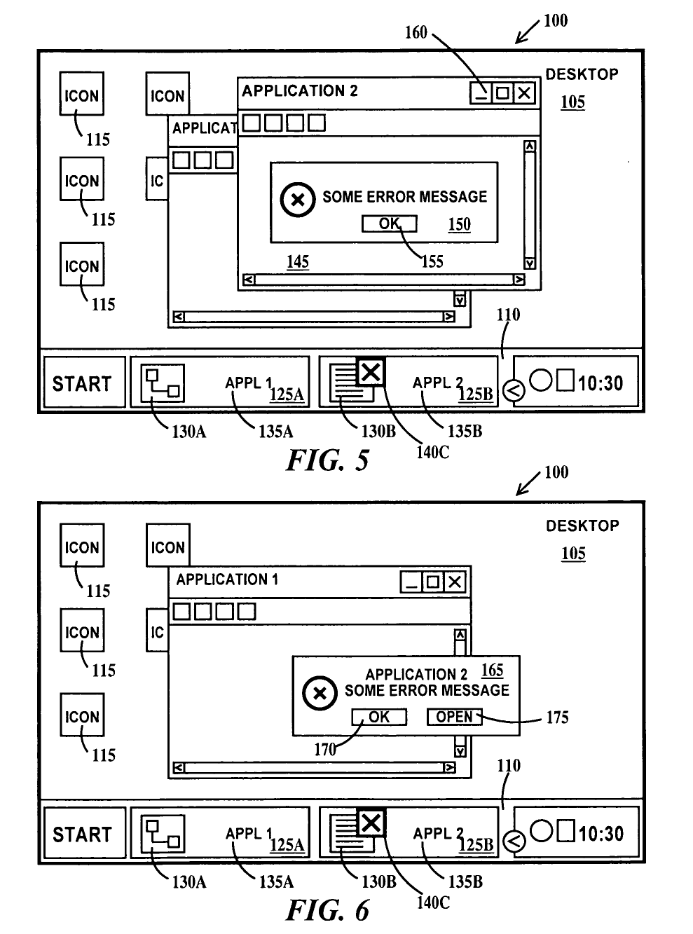

FIG. 4 is a schematic drawing of a user desktop illustrating the out-of-focus application indicating an error has occurred according to embodiments of the present invention. In FIG. 4, the second application has again changed state where processing has been stopped because of an error. To inform the user of the new status of the second application (i.e., processing has stopped because an error has occurred) an overlay icon 140C is imposed over standard icon 130B. In one example, overlay icon 140C is animated. In the example of FIG. 4, overlay icon 140B is square with an X. In one example, the color of overlay icon may be selected to enhance the visual clue given by the presence of the overlay icon graphics. For example, overlay icon 140C may have a red background. In one example, an audio clue may be associated with overlay icon 140C. Combinations of animation, audio and color clues may be used together. Alternatively, standard icon 130B (see FIG. 1) is replaced with a whole new icon that includes the overlay icon 140B graphics. The out-of-focus application remains out-of-focus until the user the user presses second task button 125B, which will allow the user to respond to the error. There are two different actions possible as illustrated in FIGS. 5 and 6 and described infra.

FIG. 5 is a schematic drawing of a user desktop after a user response to an error message of the out-of-focus application according to embodiments of the present invention. In FIG. 5, the user has “pressed” task button 125B in response to the error clue and a window 145 for the second application has opened on desktop 105, bringing the second application into focus. Additionally, an error message window 150 has opened giving information about the error. After pressing an OK button 155, error message window 150 will close leaving window 145 open (the application will be in-focus) and the user may correct the error. The user may then close window 145 by pressing a minimize task button 160 returning the second application to out-of-focus operation.

FIG. 6 is a schematic drawing of an alternative user desktop after a user response to an error message of the out-of-focus application according to embodiments of the present invention. In FIG. 6, the user has “pressed” task button 125B in response to the error clue and error message window 165 giving information about the error for the second application has opened on desktop 105. However, the second application is still out-of-focus. If the user “presses” an OK button 170, error window 165 will close, the second application will remain out-of-focus and overlay icon 140C is still present. If the user “presses” an OPEN button 175, error message window 165 will close and a window similar to window 145 of FIG. 5 will open. The application will be in-focus and the user may correct the error. The user may then close this window by pressing a minimize task button returning the second application to out-of-focus mode. This alternative behavior of the application allows the user to determine when to deal with the error without changing the focus of any application.

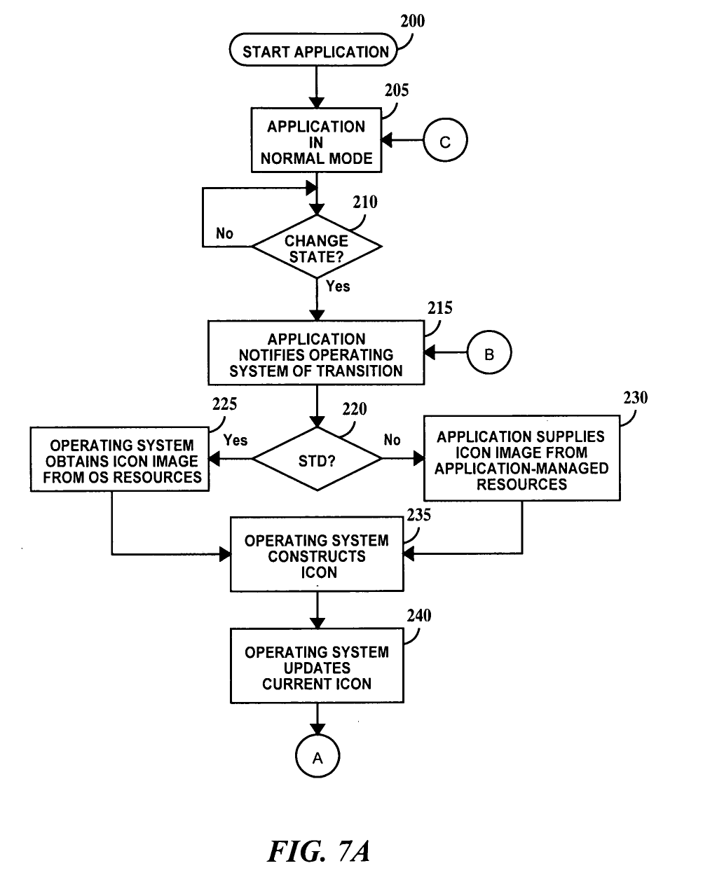

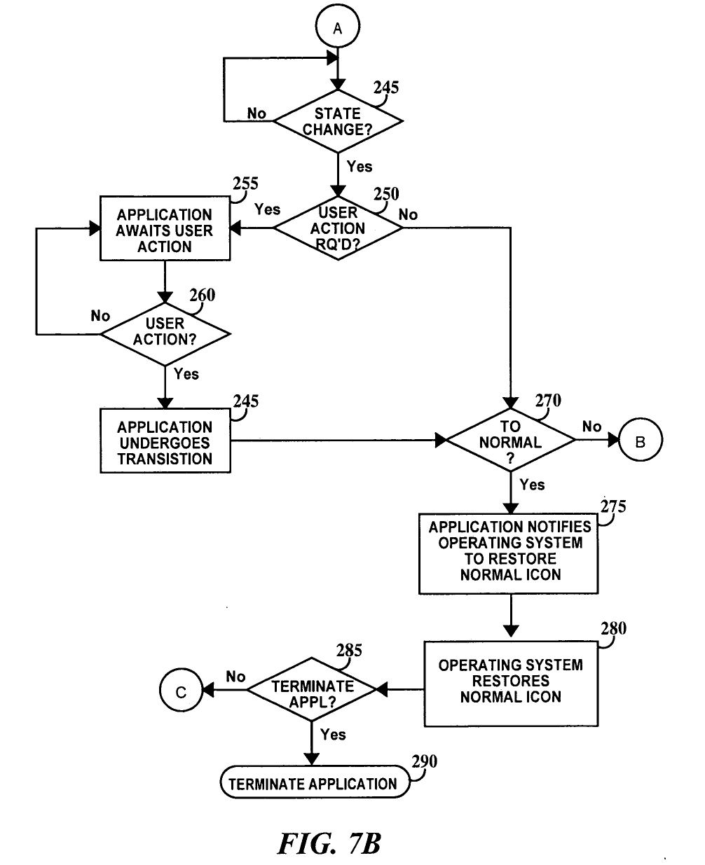

FIGS. 7A and 7B are flowcharts illustrating the method of user notification of a state transition of an out-of-focus application according to embodiments of the present invention. In step 200 the user starts an application. Alternatively, the application is started by the operating system (OS) at boot-up, at a predetermined time or day, or by another application. In step 205, the application is initialized to a normal state (i.e. idle), the application minimized (placed in out-of-focus mode) by the user, OS, or another application and a normal icon placed in the task button. In step 210, the application continually monitors itself for a change in state until a change in state occurs and the method proceeds to step 215. Examples of changes of state include but are not limited to, transitions from an idle state to processing state and vice versa, from a processing state to a input required state and vice versa, from the processing state to an error state and vice versa, and from one processing state to another processing state. A processing state is a state where the program is performing a normal task, such as a calculation, a search, downloading/uploading from/to a server, retrieving/storing information and other tasks the application was designed to perform.

In step 215, the application notifies the OS of a change in state. In step 220 it is determined if the transition is to a standard state. A standard state is a state that the application enters that has the same semantics across different applications. (for example, an error state or a user input required state). If the transition is a to a standard state, then in step 225, the OS obtains an icon image from OS managed resources, otherwise, in step 230, the application supplies an overlay icon image from application managed resources. Next in step 235, the OS constructs an updated icon and in step 240 the OS replaces the current icon (a desktop icon, a task button icon, or both) with the updated icon. The updated icon is a normal icon, an overlay icon on top of the normal icon or a new construct icon combining of both the normal icon image and the overlay icon image. The method then proceeds to step 245 of FIG. 7B.

Turning to FIG. 7B, in step 245 the application continually monitors itself for a change of state. When a change of state is detected, the method proceeds to step 250. In step 250, it is determined if user action is required. If user action is required then the method proceeds to step 255 where the application is put into a wait for user action mode and in step 260 the application continually monitors itself for user action. Then, when user action occurs, in step 265, the application undergoes the state transition and the method proceeds to step 270. Returning to step 250, if the transition requires no user action then the method proceeds directly to step 270. In step 270 if the transition is to normal mode then the method proceeds to step 275, otherwise the method proceeds to step 215 of FIG. 7A.

In step 275, the application notifies the OS to replace the current icon with the normal icon and in step 280 the OS restores the normal icon. Next in step 285, it is determined if the application is to terminate (either with or without user input). If the application is to terminate, then in step 290 the application is terminated and any task buttons removed from the task bar. Otherwise the method proceeds to step 205 of FIG. 7A.

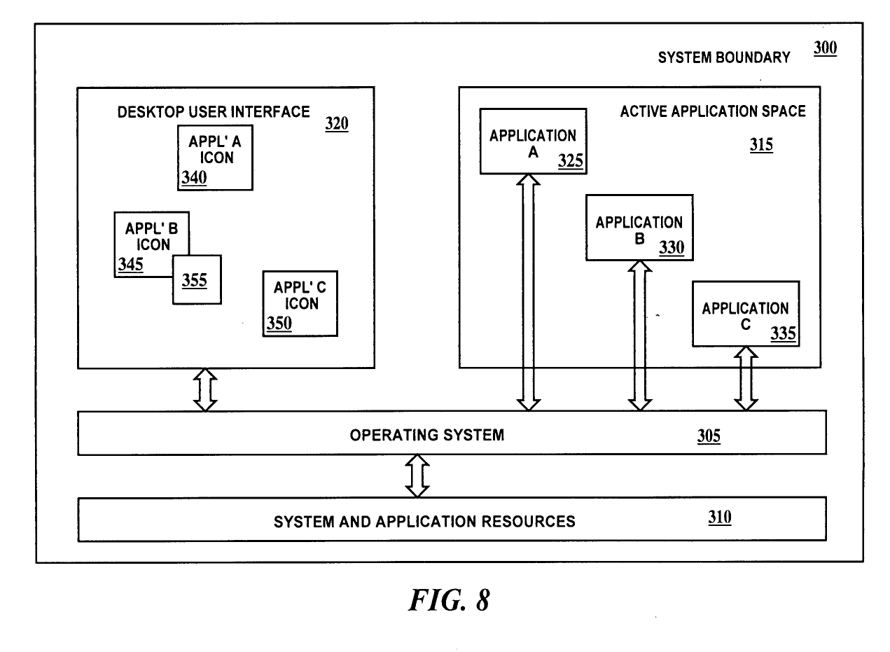

FIG. 8 is a system diagram for implementing the method of user notification of a state transition of an out-of-focus application according to embodiments of the present invention. In FIG. 8, a system boundary 300 includes an OS 305, system and application resources 310, active application space 315 and a desktop user interface 320. Active application space includes exemplary applications 325, 330 and 335. Application 325 is in-focus and applications 330 and 335 are out-of-focus. Application 330 in a non-normal state and application 350 is in a normal state. Desktop user interface 320 includes icons 340, 345 and 350. Icons 340, 345 and 350 are associated respectively with applications 325, 330 and 335. Icon 345 includes and overlay icon 355.

Applications 325, 330 and 335 interface with OS 305. OS 305 interfaces with system and application resources 310 and desktop user interface 320. Non-normal icon images and overlay icon images for applications 325, 330 and 335 are passed to system and application resources 310 through OS 305. When icons 340,345 and 350 are to be constructed as well as overlay icons such as 355, the icon image resources are retrieved from system and application resources 310 by the OS and the icons constructed in desktop user interface 320 by the OS.

Generally, the method described herein with respect to user notification of a state transition of an out-of-focus application is practiced with a general-purpose computer and the method may be coded as a set of instructions on removable or hard media for use by the general-purpose computer.

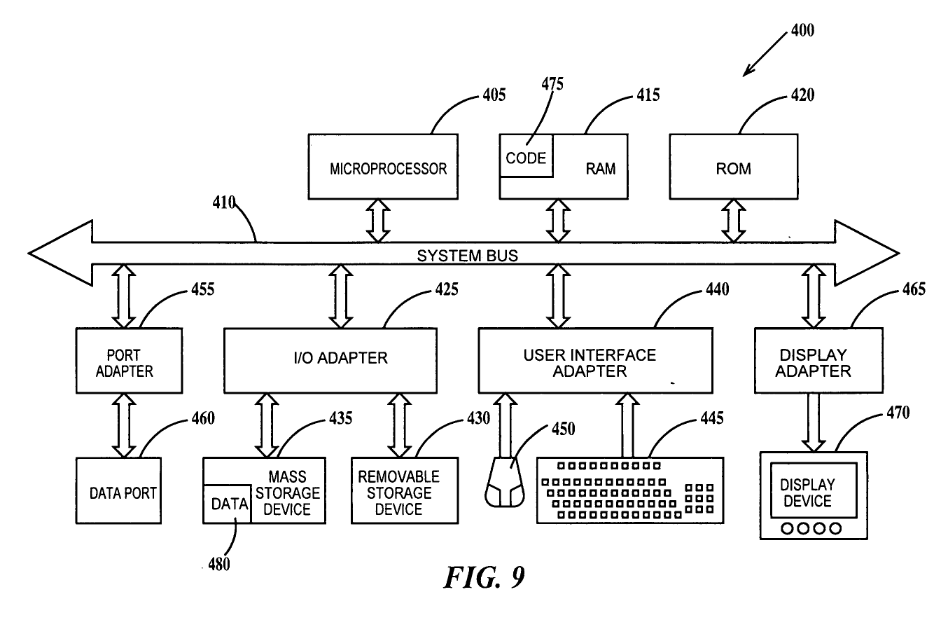

FIG. 9 is a schematic block diagram of a general-purpose computer for practicing the embodiments of the present invention. In FIG. 9, computer system 400 has at least one microprocessor or central processing unit (CPU) 405. CPU 405 is interconnected via a system bus 410 to a dynamic random access memory (DRAM) device 415 and a read-only memory (ROM) device 420, an input/output (I/O) adapter 425 for a connecting a removable data and/or program storage device 430 and a mass data and/or program storage device 435, a user interface adapter 440 for connecting a keyboard 445 and a mouse 450, a port adapter 455 for connecting a data port 460 and a display adapter 465 for connecting a display device 470.

Either of y devices 415 and 420 includes contains the basic operating system for computer system 400. Removable data and/or program storage device 430 may be a magnetic media such as a floppy drive, a tape drive or a removable hard disk drive or optical media such as CD ROM or a digital video disc (DVD) or solid state memory such as ROM or DRAM or flash memory. Mass data and/or program storage device 435 may be a hard disk drive or an optical drive. In addition to keyboard 445 and mouse 450, other user input devices such as trackballs, writing tablets, pressure pads, microphones, light pens and position-sensing screen displays may be connected to user interface 440. Examples of display devices include cathode-ray tubes (CRT) and liquid crystal displays (LCD).

One of devices 415, 420, 430 or 435 includes a computer code 475 (illustrated by way of example in device 415), which is a computer program that comprises computer-executable instructions. Computer code 475 includes an algorithm for notification of a user of a state transition of an out-of-focus software application (e.g. the algorithm of FIGS. 7A and 7B). CPU 405 executes computer code 475. Any of devices 415, 420, 430 or 435 may include input data 480 (illustrated by way of example in device 435) required by computer code 475. Display device 470 displays output from computer code 475.

Any or all of devices 415, 420, 430 and 435 (or one or more additional memory devices not shown in FIG. 9) may be used as a computer usable medium (or a computer readable medium or a program storage device) having a computer readable program embodied therein and/or having other data stored therein, wherein the computer readable program comprises computer code 475. Generally, a computer program product (or, alternatively, an article of manufacture) of the computer system 400 may comprise said computer usable medium (or said program storage device).

Thus the present invention discloses a process for supporting computer infrastructure, integrating, hosting, maintaining, and deploying computer-readable code into the computer system 400, wherein the code in combination with the computer system 90 is capable of performing a method for user notification of a state transition of an out-of-focus application.

Thus the embodiments of the present invention provide a method for applications to notify the user of an applications status or need for attention without interrupting the user and the application the user is currently working with.

The description of the embodiments of the present invention is given above for the understanding of the present invention. It will be understood that the invention is not limited to the particular embodiments described herein, but is capable of various modifications, rearrangements and substitutions as will now become apparent to those skilled in the art without departing from the scope of the invention. Therefore it is intended that the following claims cover all such modifications and changes as fall within the true spirit and scope of the invention.

What is claimed is:

1. A method, comprising:
monitoring the state of a software application, said application having multiple possible states, said application running in out-of-focus mode;
displaying a displayed icon on a computer screen indicating a current state of said application; and
in response to a change of state of said application from said current state to a new state, changing said displayed icon representing said current state to a different displayed icon representing said new state, said application continuing to run in out-of-focus mode.

2. The method of claim 1, wherein each state of said multiple possible states is independently selected from the group consisting of an idle state, a processing state, an input required state and an error state.

3. The method of claim 1, further including:
changing the mode of said application from said out-of-focus mode to an in-focus mode in response to a user selecting said application.

4. The method of claim 1, wherein said changing said displayed icon includes (1) when said displayed icon is a standard icon, adding an overlay icon to said standard icon, said standard icon identifying said application and said overlay icon indicating said new state of said application or (2) when said displayed icon includes an overlay icon over said standard icon, changing said overlay icon, said changed overlay icon indicating said new state of said application or (3) when said displayed icon includes an overlay icon over said standard icon, removing said overlay icon, said standard icon indicating said new state of said application.

5. The method of claim 1, further including:
said application providing icon image resources for at least one displayed icon representing a state of said possible states.

6. A computer program product, comprising a computer useable medium having a computer readable program therein, wherein the computer readable program when executed on a computer causes the computer to:
execute an application coded in said computer readable program;
monitor the state of said application, said application having multiple possible states, said application running in out-of-focus mode;
display a displayed icon on a computer screen indicating a current state of said application; and
in response to a change of state of said application from said current state to a new state, change said displayed icon representing said current state to a different displayed icon representing said new state, said application continuing to run in out-of-focus mode.

7. The computer program product of claim 6, wherein each state of said multiple possible states is independently selected from the group consisting of an idle state, a processing state, an input required state and an error state.

8. The computer program product of claim 6, wherein the computer readable program when executed on a computer further causes the computer to:
change the mode of said application from said out-of-focus mode to an in-focus mode in response to a user selecting a graphical representation of said application.

9. The computer program product of claim 6, wherein said changing said displayed icon includes (1) when said displayed icon is a standard icon, adding an overlay icon to said standard icon, said standard icon identifying said application and said overlay icon indicating said new state of said application or (2) when said displayed icon includes an overlay icon over said standard icon, changing said overlay icon, said changed overlay icon indicating said new state of said application or (3) when said displayed icon includes an overlay icon over said standard icon, removing said overlay icon, said standard icon indicating said new state of said application.

10. The computer program product of claim 6, the computer readable program when executed on a computer further causes the computer to:
provide icon image resources for at least one displayed icon representing a state of said possible states of said application from image resources derived from said application.

11. A computer system comprising a processor, an address/data bus coupled to said processor, and a computer-readable memory unit coupled to communicate with said processor, said memory unit containing instructions that when executed implement a method for dynamically notifying a user of a change in state of an application running on said computer system, said method comprising the computer implemented steps of:
monitoring the state of said application, said application having multiple possible states, said application running in out-of-focus mode;
displaying a displayed icon on a computer screen indicating a current state; of said application; and
in response to a change of state of said application from said current state to a new state, changing said displayed icon representing said current state to a different displayed icon representing said new state, said application continuing to run in out-of-focus mode.

12. The computer system of claim 11, wherein each state of said multiple possible states is independently selected from the group consisting of an idle state, a processing state, an input required state and an error state.

13. The computer system of claim 11, the method further including the step of:
changing the mode of said application from said out-of-focus mode to an in-focus mode in response to a user selecting a graphical representation of said application.

14. The computer system of claim 11, wherein said changing said displayed icon includes (1) when said displayed icon is a standard icon, adding an overlay icon to said standard icon, said standard icon identifying said application and said overlay icon indicating said new state of said application or (2) when said displayed icon includes an overlay icon over said standard icon, changing said overlay icon, said changed overlay icon indicating said new state of said application or (3) when said displayed icon includes an overlay icon over said standard icon, removing said overlay icon, said standard icon indicating said new state of said application.

15. The computer system of claim 11, the method further including the step of said application providing icon image resources for at least one displayed icon representing a state of said possible states.

16. A process for supporting computer infrastructure, said process comprising providing at least one support service for at least one of creating, integrating, hosting, maintaining, and deploying computer-readable code in a computing system, wherein the code in combination with the computing system is capable of performing a method for user notification of a state transition of an out-of-focus application, said method comprising:
monitoring the state of said application, said application having multiple possible states, said application running in out-of-focus mode;
displaying a displayed icon on a computer screen indicating a current state of said application; and
in response to a change of state of said application from said current state to a new state, changing said displayed icon representing said current state to a different displayed icon representing said new state, said application continuing to run in out-of-focus mode.

17. The method for supporting an application of claim 16, wherein each state of said multiple possible states is independently selected from the group consisting of an idle state, a processing state, an input required state and an error state.

18. The method for supporting an application of claim 16, wherein the application is operable to perform the following further functions of:
changing the mode of said application from said out-of-focus mode to an in-focus mode in response to a user selecting a graphical representation of said application.

19. The method for supporting an application of claim 16, wherein said changing said displayed icon includes (1) when said displayed icon is a standard icon, adding an overlay icon to said standard icon, said standard icon identifying said application and said overlay icon indicating said new state of said application or (2) when said displayed icon includes an overlay icon over said standard icon, changing said overlay icon, said changed overlay icon indicating said new state of said application or (3) when said displayed icon includes an overlay icon over said standard icon, removing said overlay icon, said standard icon indicating said new state of said application.

20. The method for supporting an application of claim 16, wherein the application is operable to perform the following further functions of:
providing icon image resources for at least one displayed icon representing a state of said possible states.
